(19) United States
(12) Patent Application Publication
(10) Pub. No.: US 2009/0277353 A1
(43) Pub. Date: Nov. 12, 2009

(54) Test form for determining the state and the setting of the dampening unit system of an offset printing press, and method for setting

(76) Inventor: Dieter Kirchner, Radebeul (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 12/308,775

(22) PCT Filed: Jun. 22, 2007
(86) PCT No.: PCT/DE2007/001138

§ 371 Date: Dec. 22, 2008

(30) Foreign Application Priority Data
Jun. 23, 2006 (DE) 10 2006 029 618.4

(51) Int. Cl. B41F 33/00

(52) U.S. Cl. 101/484

(57) ABSTRACT

A test form for determining the state and the setting of the dampening unit system of an offset printing press and to a method for this setting using the test form. The test form makes it possible to derive an application amount of dampening solution and to represent precisely possible defects in the dampening unit system of the printing unit of an offset press. The test form is characterized by a printing plate having a mirror-symmetrical arrangement of two pattern profiles which have a large area and extend substantially transversely over the entire printing plate, wherein the mirror plane (line) extends transversely with respect to the printing direction, and the pattern profiles, in relation to the area coverage, decrease starting from one edge of the printing plate as far as the mirror plane (line) and increase again from the latter in the direction of the opposite edge.

The invention pertains to a test form for determining the state and the setting of the dampening unit system of an offset printing press according to the introductory clause of claim 1 and to a method for setting it according to the introductory clause of claim 14.

So far, the correct rate at which the dampening solution is to be applied is determined empirically by means of an iterative procedure. No conclusions based on technical measurements are drawn concerning the best possible result which might be achieved or about any possible technical defects which might be present in the state of the dampening unit system.

The goal of the invention is to create a test form which makes it possible to derive the best possible rate of dampening solution application and to obtain accurate evidence of possible defects in the dampening unit system of the printing couple of an offset press.

This goal is achieved according to the invention by the features of claim 1.

Preferred elaborations can be derived from the subclaims.

So that the invention can be better understood, it should be noted at the beginning that the term “screen profile” used below is to be understood as a screen which changes with respect to the way in which it covers a given surface. In the present case, this change in the screen profile occurs only in the printing direction. Independently of the term “screen profile”, the term “screen field” is also used. This is a defined region in which the area coverage is specified and remains uniform.

In order to achieve the highest possible print quality (image reproduction and properties associated with further processing), it is usually desirable to determine the least possible amount of dampening solution (usually water with a neutral pH and certain chemical additives) which can be applied to an offset master and to keep this amount constant.

The amount of dampening solution applied by a dampening unit system of a printing couple is usually determined by way of a metering device, which can be designed technically in various ways (ductor dampening units, film dampening units, indirect ink application via inking rollers, brush dampening units, and centrifugal dampening units). The present description applies to all types of these metering systems, but the invention will be described here on the basis of the “dipping roll”, the most commonly used method, as an example.

The test form consisting essentially of a printing plate with two screen profile areas which are arranged as mirror images of each other and which have been produced on the printing plate by exposure at a resolution of 60-80 l/cm. The screen profile is designed in such a way that the area coverage decreases in the printing direction as far as the mirror plane (line), as a result of which the water absorption capacity increases. Because the arrangement is mirror-symmetric, the screen profile after the mirror plane (line) is correspondingly reversed; that is, the area coverage increases, whereas the water absorption capacity therefore decreases.

This screen profile leads to the effect that, in the case of a dampening unit system with a certain setting, a tear-off edge will appear on the printed sheet at which there is a separation between a free-running and a non-free-running screen. From the profile and the position of this tear-off edge, it is now possible to derive information useful in determining the setting of the dampening unit system and even to derive the presence of defects or damage in this system, as will be described below.

The large-area profile which starts with an area coverage of 80% and decreases to a coverage of 2% as it proceeds toward the center of the sheet, where it is terminated preferably by a full-tone strip, is used to determine the technical state of the dampening unit system and the optimal rate of dampening solution application. A mirror image of this profile is then repeated on the second half of the sheet.

For the actual evaluation of the printing result, it is highly advantageous to provide a so-called “jump” in density after the first fourth of the screen profile in the printing direction. In front of this density jump, the profile stops changing at an area coverage of 50%, which extends over the entire width of the plate, i.e., transversely to the printing direction, and remains at this value over a distance of, for example, 8 mm. The profile starts to decrease again on the other side of this strip of uniform area coverage (50%), but the area coverage at this new starting point is only 47%. It is at this edge that the tear-off edge should be located during the subsequent course of the process. The profile continues to decrease from this point on until it reaches an area coverage of 2% at the mirror plane (line). If desired, the previously mentioned full-tone strip can form the boundary here. The tear-off edge separates the areas in which the screen profile can be overloaded with ink (smeared) because of an insufficient supply of dampening solution from areas in which the screen dots are already sharply defined. Even very small changes in the metering rate become visible in the critical region of the density jump where the combination occurs. The dipping roller, which is responsible for metering the dampening solution, must be set in such a way that the smear boundary is as straight as possible at the printed density jump transverse to the printing direction.

Rectangular screen fields with stepped area coverage are arranged vertically along both edges of the plate and in the center of the plate. These 3 stepped screen wedges are used to determine the characteristic printing curve. This determination is carried out after the process of adjusting the dampening unit has been completed and the best possible dampening solution application rate has been determined. The arrangement, seen in the printing direction, of the stepped wedges in the center and along the two edges of the plate ensures that the same characteristic curve is obtained over the entire sheet. The tolerance between the measurements in the printing direction may not exceed a density value of 1%. The same purpose is served by the bar-like full-tone area. The maximum print density (amount of ink applied) should be measured here and should be free of fluctuations across the width of the sheet.

A full-tone bar extends across the entire width of the center of the test form; according to one embodiment, this bar is interrupted by three rectangular fields with 50% area coverage. These screen fields are located in the center and at the two extremes of the full-tone bar. If the dampening unit is set correctly, the tonal value must increase in the same way in all three screen fields. A tolerance of 1% in density should not be exceeded. According to another embodiment, the full-tone bar is surrounded by a frame with 50% area coverage. The evaluation can then be carried out in corresponding fashion.

At the bottom edge of the test form or printing plate, screen fields with different area coverages are arranged transversely to the printing direction across the entire width. These are combined with a full-tone bar, which also extends over the entire width, transversely to the printing direction. These screen fields have three different area coverages and are repeated over the width of the plate. The fields with area coverages of 94%, 90%, and 80% are selected when it is desired to make fine adjustments to the metering rate of the dampening solution. At these high area coverages with extremely small “exposed” water-carrying surfaces, it is possible to detect extremely small deviations from the optimal dampening solution supply. This arrangement is intended to answer the question about where the “lower smear boundary” is. The distribution of the screen areas over the width of the plate provides information on the uniformity of the results.

The smear boundary (tear-off edge) is defined as the “separation line” between an area which has been overloaded with ink and an area which has taken up the normal amount of ink.

The setting is not considered adequate if a highly wavy tear-off is obtained between the two areas just mentioned at the starting setting (basic setting of the dipping roller). The cause can be an incorrect setting as just mentioned, which it is now the goal to detect and to optimize by measurement in a few steps, or there can be a defect in the dampening unit system itself (wrong roller material; used-up, worn-out roller), which can be corrected only by replacement measures.

In almost all cases, a visible smear boundary will become visible, the course of which suggests a greater or lesser need for optimization. If a smear boundary is visible, it will extend in a wave-like manner horizontally along the density jump, where the shape of the wave, that is, the distances between the peaks and valleys of the wave, can vary from minor to extreme. The amplitudes of a wavy smear boundary extending over the sheet in the printing direction provide preliminary information on the corrective measures which must be taken.

As a result of the mirror-image screen profiles, two tear-off edges, which are essentially mirror images of each other, are formed on the test printings. If their profiles or shapes deviate from each other more than the tolerance allows, the setting is incorrect or there is a defect in the dampening unit system.

By changing the speed of the dipping roller (rotation in m/s, represented by the % value entered into the dampening unit), a greater or lesser amount of dampening agent will be transferred to the printing form. This causes the smear boundary to shift.

By means of controlled changes in the dipping roller speed, that is, in the amount of dampening solution supplied, the amplitude peaks of the smear boundary wave can be moved to the density jump. If this does not work, the amount of dampening solution required is so high that it is no longer possible to obtain high-quality printing. The only measure when can be taken then is to replace the dipping roller system or the entire dampening unit.

If the smear boundary curve is situated such that, when the dipping roller speed is changed by 2% from a base setting of 40%, the peak amplitudes are positioned directly at the density jump, then the dampening solution supply (corresponding to about 5% more dampening solution) is at the best possible setting and the dipping roller is technically free of defects.

If the amplitudes of the curve made visible by the smear boundary do not reach the density jump when the dipping roller speed is changed within the 2% tolerance range (corresponding to approximately 5% more dampening solution), then a larger quantity of dampening solution (up to a maximum of 20%) is necessary. If this application rate is still not enough to bring the amplitudes up to the density jump, the dipping roller has a technical defect and must be replaced.

The individual steps of the process of conducting the test and the following adjustment are as follows:

Step 1:

Expose the test form elements in a direct imaging system for offset plates to produce the printing plate. This is generally known.

Step 2:

After the plate has been mounted in an offset printing couple of the offset printing press to be adjusted, the inking should be metered via the inking couple according to the press manufacturer's instructions. The ink zone presetting of the inking couple can be taken from the digital database of the test form via the CIP 3 precalculation of the area coverage to be expected.

Step 3:

There are dipping rollers with different dip volumes. The speed of the dipping roller is adjusted to approximately 30%, 40%, or 50%, depending on its dip volume (where 100% means a rotational speed x relative to the printing speed).

A first test printing is conducted to determine the position of the tear-off edge at the conventional setting.

Now the dipping roller must be set in such a way that the tear-off edge is brought close to the density jump, where conclusions concerning any possible defects in the dipping roller or in the dampening unit system—as previously described—can be drawn from the shape of the wave. The tear-off edge should lie as uniformly as possible within the tolerance at this density jump transverse to the printing direction. The tolerance is 1.5% at a dipping roller speed of 30%, 2% at a speed of 40%, and 2.5% at a speed of 50%.

If, according to the previously described test printings after interim corrections of the dampening unit/dampening solution feed rate, the tear-off edge now extends with low amplitude peaks essentially along the printed density jump, then, in the next step, it is possible to “move” the tear-off edge outside the printed area by changing the dampening solution feed and then, upon successful completion of a test phase, to operate the printing press with this setting in normal operating mode.

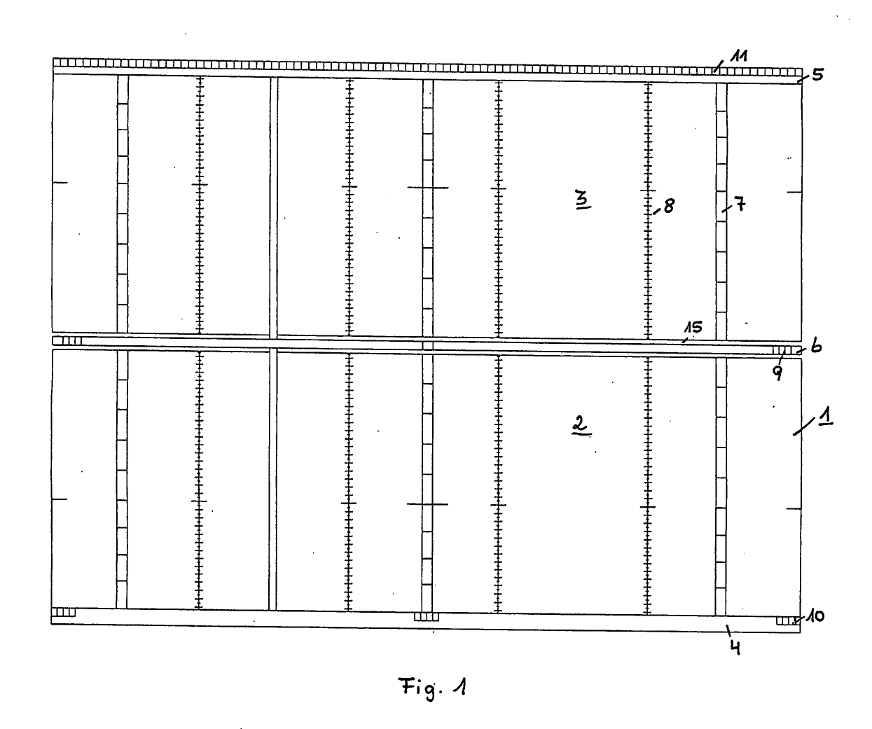

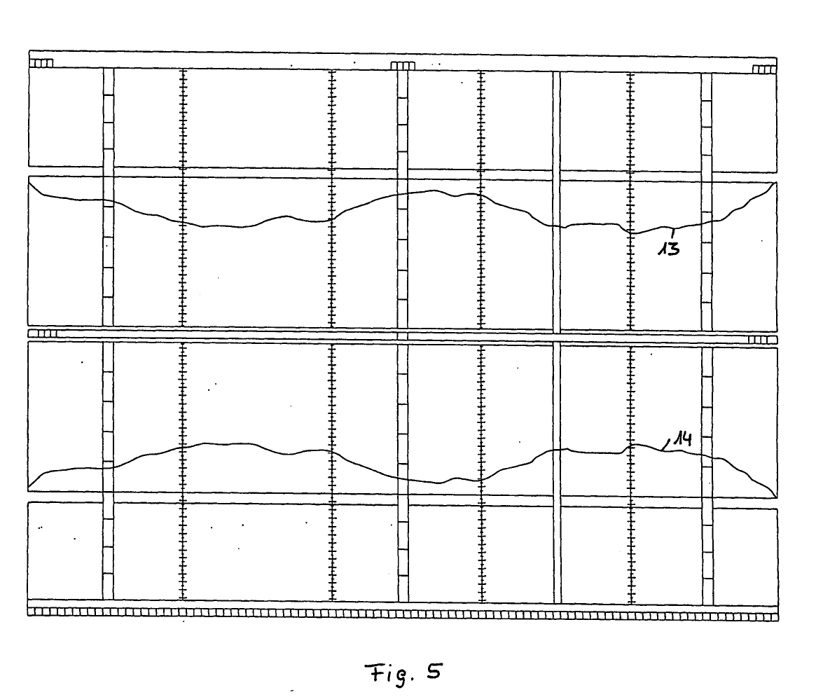

The invention is to be explained again with reference the drawings. FIGS. 1-5 each show a printing plate, designated by the number 1. The screen profiles 2 and 3, which are arranged as mirror images of each other, are separated by a full-tone area 6. In the exemplary embodiment shown here, the full-tone area is surrounded by a frame 15 with an area coverage of 50%. The edge of the printing plate is designated 4, that of the test form 5. Screen fields 10 and 11 are provided along the two opposite edges, and a screen field 9 is provided in the full-tone strip. Screen fields 7 and stagger marks 8, furthermore, extend along the printing plate 1 in the printing direction. The effect of these screen fields and stagger marks, i.e., the way in which they are evaluated, has already been described above.

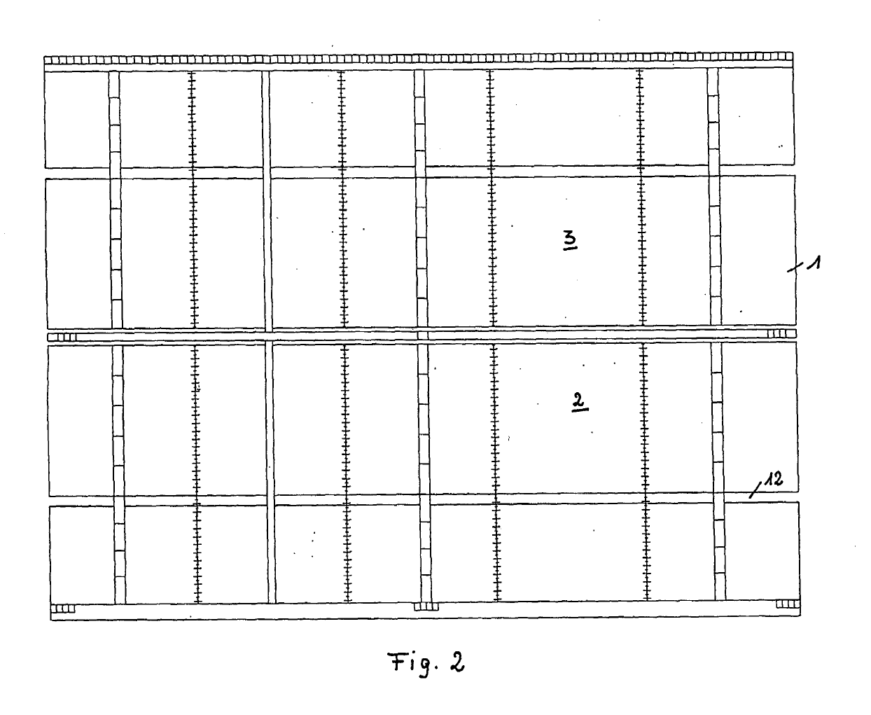

FIG. 2 shows the density jump 12 within the large-area screen profiles 2 and 3.

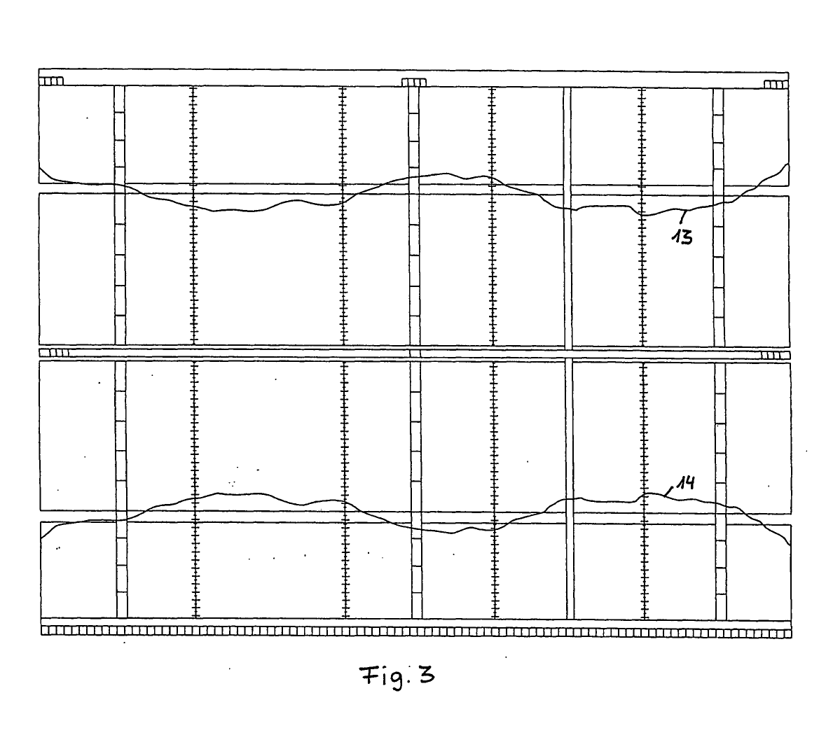

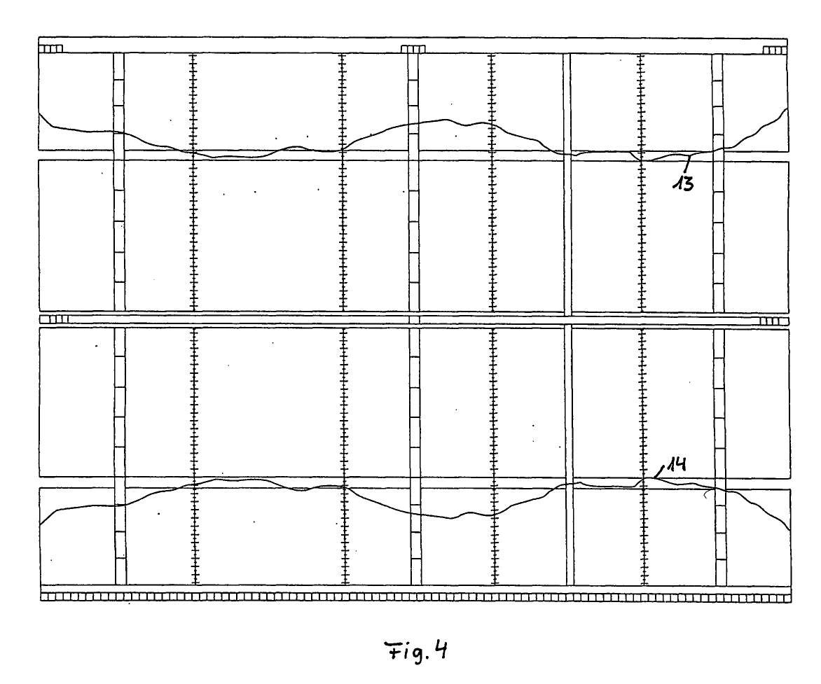

FIGS. 3-5 show the tear-off edges 13 and 14, each in relation to the density jump, where the tear-off edge which has been brought the closest to the density jump is shown in FIG. 4, this being the edge which is then used for the corresponding calculation of the correct setting of the dipping roller. The greater water uptake which can be seen the middle area lies within a tolerance range, so that it can be ignored.

1.-14. (canceled)

15. A test form for determining state and setting of a dampening unit system of an offset printing press, comprising:
a printing plate having a mirror-image arrangement of two large-surface-area screen profiles, the two large-surface-area screen profiles extending substantially over the entire printing plate,
wherein a mirror plane is transverse to a printing direction, and an area coverage of one screen profile decreases from an edge of the printing plate to the mirror plane, whereas an area coverage of the other screen profile increases again from the mirror plane in the direction toward an opposite edge of the printing plate.

16. The test form according to claim 15, wherein the area coverage begins at substantially 80% at the edge of the plate and ends at substantially 2% at the mirror plane.

17. The test form according to claim 16, wherein a screen profile extends across the width of the plate, the profile has an area coverage of substantially 80% at the edge of the printing plate and decreases to 50% as it proceeds toward the mirror plane, the profile remains at 50% over a narrow section, then jumps to a density of 47% and decreases from 47% as it continues toward the mirror plane, where the profile has an area coverage of substantially 2%.

18. The test form according to claim 15, wherein the mirror plane is a narrow full-tone strip.

19. The test form according to claim 18, wherein rectangular screen fields comprising stepped area coverages transverse to the printing direction are arranged a certain distance apart at the two edge areas of the printing plate and in the narrow full-tone strip.

20. The test form according to claim 19, wherein the rectangular screen fields in the narrow full-tone strip have 50% area coverage.

21. The test form according to claim 19, wherein rectangular screen fields having different degrees of area coverage are arranged along the edge of the printing plate.

22. The test form according to claim 21, wherein the individual rectangular screen fields comprise three different repeating degrees of area coverage.

23. The test form according to claim 22, wherein the three different repeating degrees of area coverage are substantially 94%, 90%, and 80%.

24. The test form according to claim 18, wherein the narrow full-tone strip is surrounded by a frame with 50% area coverage.

25. The test form according claim 15, further comprising at least two stepped screens configured to measure the characteristic printing curve arranged on the printing plate a certain distance apart in the printing direction.

26. The test form according to claim 25, wherein the stepped screens differ by 10%.

27. The test form according to claim 18, further comprising an additional full-tone strip extending from edge to edge of the printing plate in the printing direction configured to measure the decrease in ink.

28. A method for setting a dampening unit system of an offset printing press with the use of a test form a printing plate having a mirror-image arrangement of two large-surface-area screen profiles, the two large-surface-area screen profiles extending substantially over the entire printing plate, wherein a mirror plane is transverse to a printing direction, and an area coverage of one screen profile decreases from an edge of the printing plate to the mirror plane, whereas an area coverage of the other screen profile increases again from the mirror plane in the direction toward an opposite edge of the printing plate, the method comprising:
performing a test printing at a first setting of the dampening unit system to determine a position of a tear-off edge on a printed sheet;
changing a speed of a dipping roller of the dampening unit system to move the tear-off edge close to the density jump;
evaluating a state of at least one of the dipping roller and the dampening unit system from a course of the tear-off edge transverse to the printing direction; and
correcting the tear-off edge by changing a last dampening solution feed to move the tear-off edge from a printed image after the test phase.

29. The method for setting a dampening unit system according to claim 28 comprising repeating the test printing and the changing of the speed.
